(19) United States
(12) Patent Application Publication
(10) Pub. No.: US 2013/0298878 A1
(43) Pub. Date: Nov. 14, 2013

(54) CANISTER EQUIPPED WITH HEATER

(71) Applicant: KOREA FUEL-TECH CORPORATION, Gyunggi-Do (KR)

(72) Inventors: Hyun Ki Kim, Seoul (KR); Tae Kyu Hwang, Seoul (KR); Joon Young Choi, Seoul (KR); Hyung-Jun Bae, Seoul (KR)

(73) Assignee: KOREA FUEL-TECH CORPORATION, Gyunggi-Do (KR)

(21) Appl. No.: 13/742,166

(22) Filed: Jan. 15, 2013

(30) Foreign Application Priority Data
May 8, 2012 (KR) 2012-0048397

(51) Int. Cl. F02M 25/08

(52) U.S. Cl. CPC F02M 25/0854
USPC 123/519

(57) ABSTRACT

The invention provides a canister for reducing emissions of fuel gas. Fuel gas absorbed onto active carbon inside a canister can be easily desorbed from the active carbon and then flow into canister in the engine. The canister, which is combined with fuel tank and throttle pipe for absorption and desorption of fuel gas generated in fuel tank, has following components: a fuel tank port and an air inlet formed at the upper end of one side; a junction pipe arranged in upper parts of this side; a canister body with a plurality of convex is formed; a junction configured to fit the junction pipe on the canister body formed at upper end of the canister body and a plurality of hooks connected with a plurality of convexes on the canister body are provided; air inlet set on an upper side, a heater with a heater module is set inside.

### CROSS REFERENCE TO RELATED APPLICATIONS

This application claims the priority of Korean Application No. KR 2012-0048397 filed on May 8, 2012, the disclosure of which is incorporated by reference in its entirety.

### TECHNICAL FIELD OF THE INVENTION

The invention relates to canisters for vehicles to efficiently reduce fuel gas, in particular fuel gas absorbed onto active carbon (active charcoal) in canisters. With this invention, fuels can be separated from active carbon more easily and then flow into engine efficiently.

### BACKGROUND OF THE INVENTION

In general, devices that store fuel gas generated inside fuel tank and then transfer the gas to engines are equipped on vehicles. Such devices are called canisters.

Under general circumstances, fuels utilized to drive engines are stored inside fuel tanks. Under the impacts of surrounding and related factors, fuels inside fuel tanks will be gasified. Such gas contains some hazardous constituents, such as HC (hydrocarbon). Emission of the gas will lead to air pollution and fuel waste.

During engine idle periods, the canisters will absorb gas from fuel tanks onto active carbon (active charcoal). When the engine starts running, the stored gas may be transferred to the engines to effectively prevent air pollution and fuel waste. The canister (1) (cf. FIG. 1) has been disclosed in public patent gazette No. 2004-90740, 2004-17053, 2003-89139 and 2001-36538 of the Republic of Korea.

FIG. 1 shows a system diagram illustrating a connection status of canister (1) and fuel tank (2). As shown in FIG. 1, an inflow pipe (3) of the canister (1) is connected with the fuel tank (2). After an engine stops running, gas generated inside the fuel tank (2) will flow into the canister (1) through the inflow pipe (3) under internal pressure of the fuel tank.

The canister (1) mentioned above is internally filled with active carbon (active charcoal) to absorb gases. Gas flowing in through the inflow pipe (3) as described-above will be absorbed onto the active carbon inside the canister (1). However, other gas not absorbed onto the active carbon will be discharged into air through a discharge pipe (4) arranged on the canister (1).

Meanwhile, the canister (1) and a throttle pipe (6) are connected with each other through a guide pipe (5). The guide pipe (5) is equipped with a control valve (7) to limit inflow gas from the canister (1) to the throttle pipe (6). After the engine stops running, the control valve (7) is closed. It will open when the engine is running.

After a driver starts an engine, air will be delivered into the engine through the throttle pipe (6). In such situation, the internal pressure of the throttle pipe (6) is lower than the normal air pressure. Therefore, external air will flow into the throttle pipe (6) through the discharge pipe (4), the canister (1) and the guide pipe (5). Furthermore, the external air, the inflow air, and the gas absorbed onto the active carbons in inside the canister (1) are delivered into engine through the throttle pipe (6).

Active carbons inside the canister (1) described above have the following features:
1. During gas absorption, gas in the gas phase will be absorbed onto the active carbons, where it is liquefied under the impact of the active carbons. Heat generated during liquefaction is emitted out of the canister.
2. The liquefied gas absorbed onto the active carbons will flow into the engine due to inhalation (in-taking) of external air. Liquid fuels absorbed onto the active carbons will be gasified into gas and then carried into the engine in the form of gas. At this moment, the active carbons are able to absorb heat around the canister to convert fuels into gas.

In order to save fuel cost of gasoline vehicles and meet the requirements for environment-friendly vehicles at present, hybrid cars with the feature of consumption of both gasoline and electric power are increasing in popularity.

Such type of hybrid cars utilizes gasoline to start up and is driven by electric power under normal situations. Therefore, it reduces the volume of gas absorbed inside the canister because air is not needed when the car is driven by electric power. Accordingly, gas absorbed in the canister will increase.

With a view to solving problems described above, high performance active carbons and canisters of large capacities to better oxidize the gas absorbed onto the active carbons and then deliver the gas into engine in a shorter period shall be installed on hybrid cars.

As solutions to the above problems, a canister is disclosed in U.S. Pat Nos. 6,896,852 and 6,769,415 and in South Korean public patent No. 10-2007-49425.

According to U.S. Pat. No. 6,896,852, a canister is installed to heat inhaled gas through the discharge pipe (4). A heater will heat the air inside the canister and then delivers the air into the canister. The heated air will provide heat for the desorption reaction inside the canister to help desorb the fuels absorbed on the active carbons more easily.

However, U.S. Pat. No. 6,896,852 has encountered a problem that the temperature of the air heated by heater fails to exceed 100° C. Actually, the temperature of air after being heated and absorbed onto the active carbon is kept at about 80° C.

Besides, heated air supplied to the active carbon still exists and will be absorbed by active carbon around the suction inlet, unable to supply heat to all active carbon. Meanwhile, desorption efficiency of heated air inside a canister is low and only reaches the effect of test for PZEV (Partial Zero Emissions Vehicle).

In U.S. Pat. No. 6,769,415, a heater coil is inserted into the active carbon in the corresponding position of the discharge pipe (4) to heat the active carbon. Thus, direct active carbon heating is achieved.

However, the supplied heat in U.S. Pat. No. 6,769,415 can only be transferred in the corresponding position of the discharge pipe (4). Heat can only be transferred to the corresponding parts of the active carbon. As a result, it is unable to provide heat for all active carbon. Furthermore, the actual desorption efficiency in the canister is quite low and can only reach the effect of test for PZEV.

According to public patent No. 10-2007-49425 of the Republic of Korea, a calandria is installed inside the canister and is internally filled with sodium thiosulfate and sodium phosphate to store heat generated in the absorption reaction and to provide the stored heat to the active carbon during the desorption reaction to promote desorption performance of the fuel gas.

However, the temperature of thermal storage substances filled in the calandria shall not be higher than a specific value during desorption of fuel gas in the above patents. Therefore, these patents encounter the failure to ensure the gas desorption rate required by hybrid cars.

Furthermore, the heater will consume excessive electric power as it is utilized for heating of the gasoline and electric cars. Consequently, the car fuel cost is unreasonable.

### SUMMARY OF THE INVENTION

The invention is presented to solve some or all problems raised above. Fuel gas absorbed onto active carbons in canisters delivers necessary heat for all active carbons during desorption. This aims to provide a type of canister to effective promote desorption performance of active carbons.

A canister is provided to minimize power consumption of the heater installed for better desorption effect of the canister and then promote vehicle fuel efficiency.

As for the technical purpose, a type of heater installed in a canister that can be easily replaced is provided.

The invention relates to canisters equipped with heaters, wherein the canisters are connected with fuel tanks and throttles. The canister aims to realize both absorption and desorption of fuel gas in a fuel tank. Its characteristics are shown as follows. Fuel tank opening and air inlet are formed at an upper end on one side. Meanwhile, a junction pipe and a canister body with a plurality of junction convex are formed on this side. A junction of the junction pipe is arranged at the upper end of the canister body with an inserted junction. A plurality of hooks combined with a plurality of convex junctions on the canister body are formed. A heater with an air inlet on its upper side and combined with heater module internally is formed.

It is characterized by grooves with gland strip plugged on the outer side of junction pipe. A gland strip is arranged inside grooves as described above.

It also has features that an opening is set on a lower side of the heater. The heater body with a junction groove with a module plugged in is formed on one side, and a heater module is horizontally inserted into the junction groove.

The heater module hereinbefore is configured with a junction plate, a PTC heater, a heating groove and a power supply terminal. Wherein, the PTC heater is connected with the junction plate. The heating groove is connected with the PTC heater. The power supply terminal serves as a power source for the FTC heater.

A dispersion plate is arranged between a heater module inserted onto the heater body and heater body. Dispersion plates shall be installed onto the heater module evenly at specific spacing. The heater modules shall be installed separately on the heater body and on lower side of the heater at selected spacings.

Air flowing in through the air inlet described above will be heated when it vertically flows through the PTC heater and the heating groove. Heat generated by the PTC heater is absorbed into active carbon in the canister as described above.

A plurality of holes are distributed on the dispersion plate for air diffusion. Convex parts are formed at the center. The PTC heater can heat air to 150° C. to 180° C., for example, by means of 3-6 A current. Air flowing into the canister through PTC may be heated to 80° C. to 110° C. by the PTC heater.

According to embodiments of the invention, air flowing into the canister is heated by a heater. Meanwhile, active carbon absorbs heat generated by the heater to efficiently discharge fuel gas absorbed on the active carbons. The heater is featured by lower current consumption to promote fuel cost efficiency of vehicles. If it breaks, the heater installed at the upper end of the canister can be easily replaced.

### BRIEF DESCRIPTION OF THE DRAWINGS

FIG. 1 shows an expanded simple view of connections between a canister and a fuel tank.

FIG. 2 shows a schematic drawing of a practical canister equipped with a heater in accordance with one embodiment of the invention.

FIG. 3 shows disassembled views of the main parts of a canister in accordance with one embodiment of the invention.

FIG. 4 shows a front sectional view of a canister in accordance with one embodiment of the invention.

FIG. 5 shows an enlarged sectional view of the main parts of a canister in accordance with one embodiment of the invention.

FIG. 6 shows an expanded view of connection status between a canister and a fuel tank in accordance with one embodiment of the invention.

### DETAILED DESCRIPTION

Embodiments of the invention will be described with reference to related figures. However, the examples are used to illustrate embodiments of the invention and are not intended to limit the scope of the protection. One skilled in the art would appreciate that variations and modifications are possible without departing from the scope of the invention.

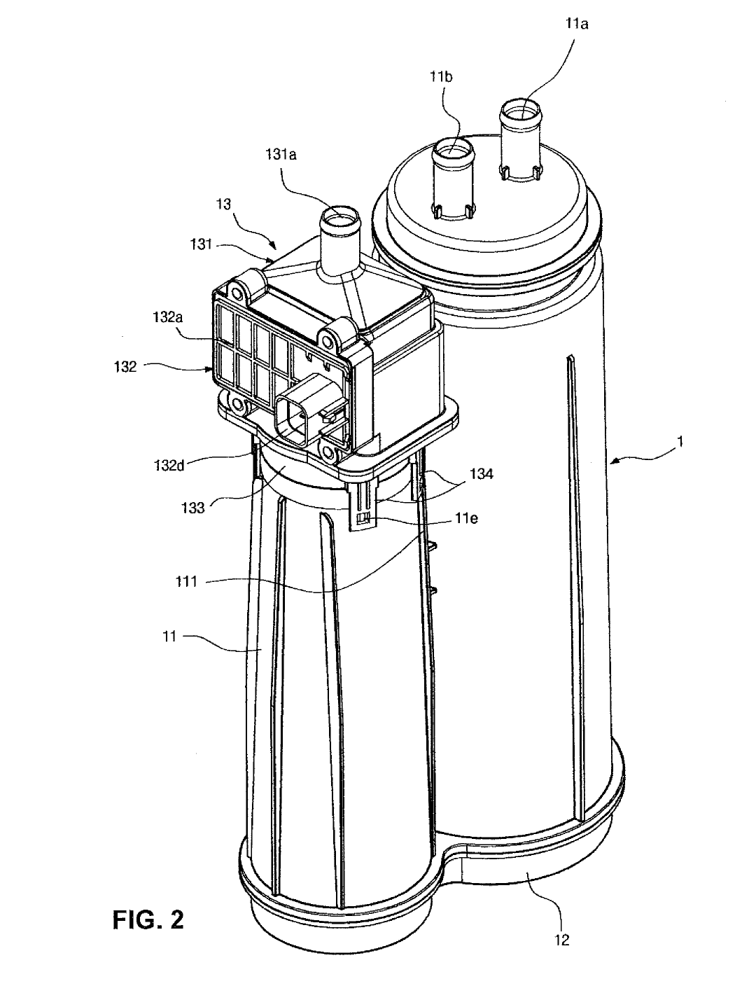

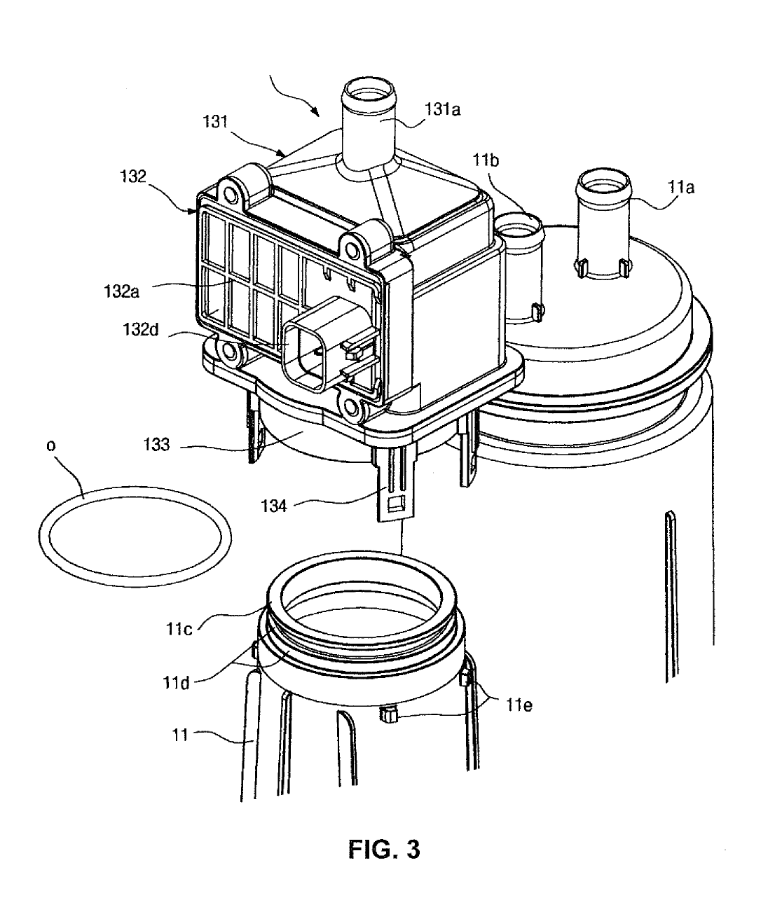

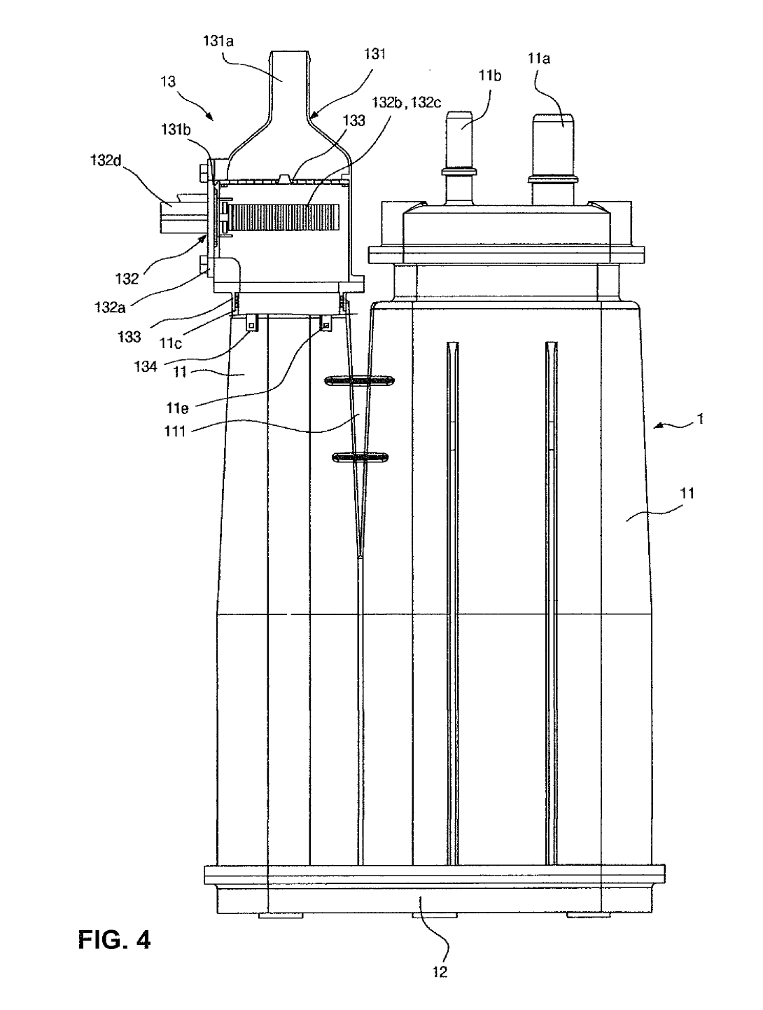

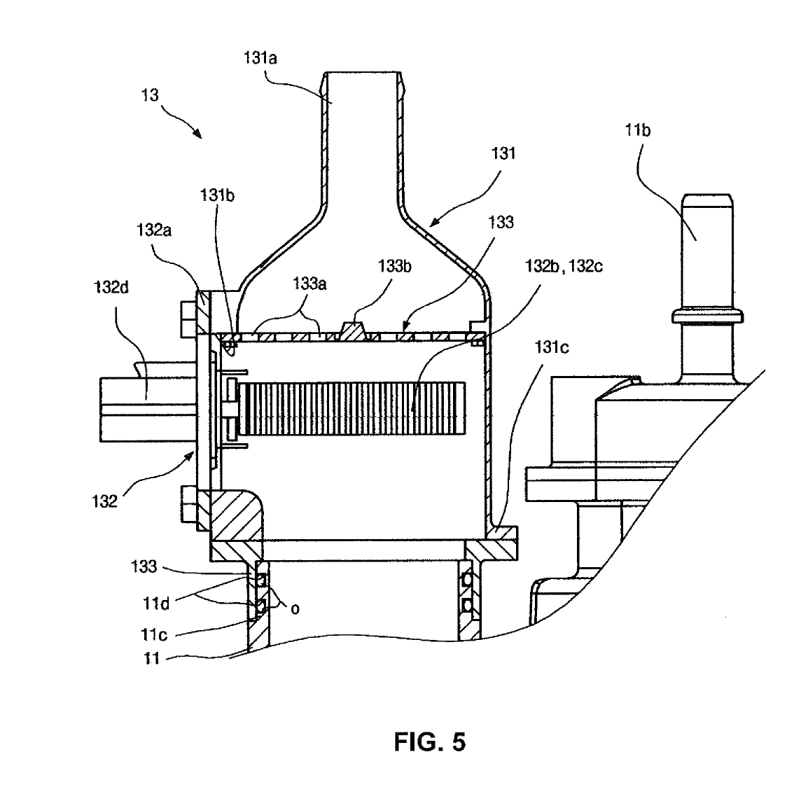

FIG. 2 shows a schematic drawing of a practical canister with a heater in accordance with one embodiment of the invention. FIG. 3 shows a disassembled view of main parts of a canister in accordance with one embodiment of the invention. FIG. 4 shows a front sectional view of a canister in accordance with one embodiment of the invention, and FIG. 5 shows an expanded sectional view of main parts of a canister in accordance with one embodiment of the invention.

Canister (1) is composed of a canister body (11), a lower plate (12) connected with lower parts of the canister body (11), and a heater (13). (see FIG. 2).

Internal parts of the canister body (11) are not shown in the figures. However, a fuel gas reduction unit, a diffusion trap, an active carbon support filter, active carbon, a filter and an elastic material are arranged inside the canister body (11).

Central parts of the canister body (11) may be arranged with the vertical partition (111) along the length to partition the internal space of the canister body (11).

An opening is arranged in lower parts of the canister body (11). It is like a ladder with its width decreasing from upper parts to lower parts. The internal space of the canister body (11) may be vertically partitioned into two spaces by the vertical partition (111), including the first space (112) and the second space (113). Active carbons are filled between the first space (112) and the second space (113).

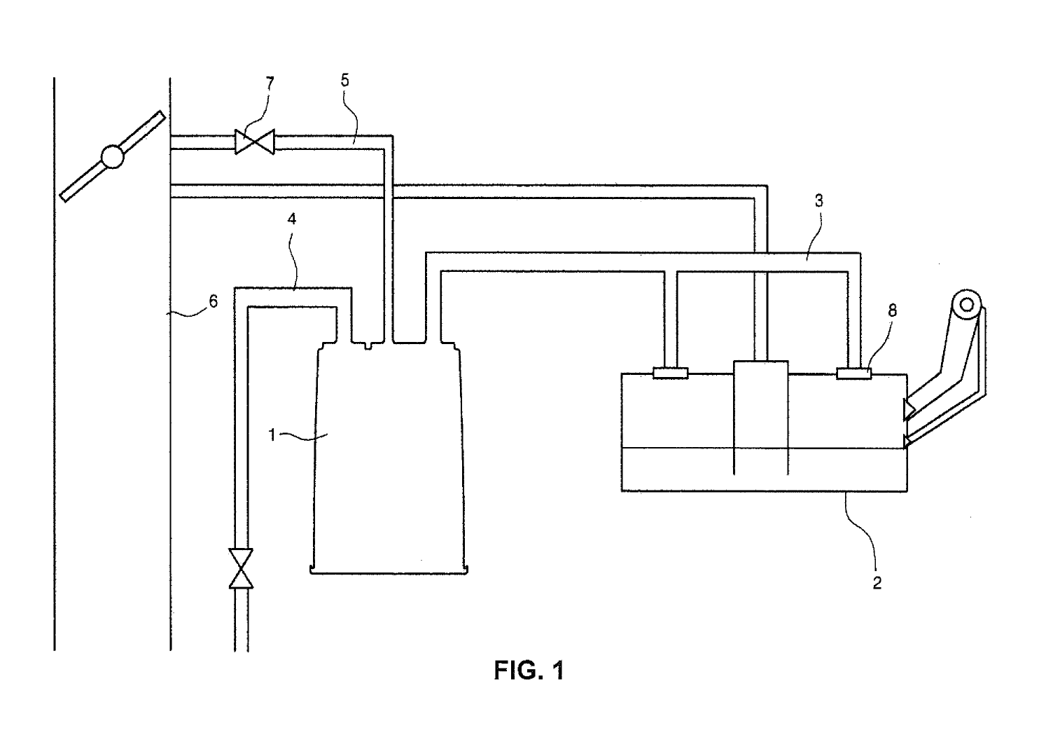

A fuel tank port (11a) enabling fuel gas generated in fuel tank (2) to flow and a cleaning port (11b) for discharging internal fuel gas to a guide pipe (5) shown in FIG. 1 are arranged on the upper side of the first space. A junction pipe (11c) (see FIG. 3) for air inhalation and emission is arranged in the central part on the upper side of the second space (113).

Although it is not shown in the figures, a diffusion trap is arranged in the upper side of the first space (112) to make inflow fuel gas through the fuel tank port (11a) pass through active carbon in a wider scope.

Although it is not shown in the figure, a filter to fully support active carbons filled between the first space and the second space is actually arranged at the lower end of the canister body (11). The filter may be fastened onto the lower plate (12) using elastic materials and bracings.

In addition, the junction pipe (11c) to connect with the heater (13) is formed on the upper side of the second space (112). A groove (11d), in which the seal components (O) are inserted, is set on the outer side of junction pipe (11c). Seal component (O) is allocated on the groove (11d). A junction pipe (11c) will be inserted onto the heater (13).

A plurality of junction convex (11e) are formed on lower side of the junction pipe (11c) on the canister body (11). The heater (13) is inserted onto the junction convex (11e).

Although it is not shown in the figure, the second space (113) is divided into a plurality of space through a plurality of bracing filter. In addition, these spaces are respectively filled with a suitable grade (e.g., grade-13 and grade-11) active carbons.

The heater (13) is composed of a heater body (131), a heater module (132) and a dispersion plate (133) installed in upper parts of the heater module (132).

An opening is arranged on the lower side of the heater body (131). An air inlet (131a) is formed on the upper side. In addition, a junction groove (131b) to connect heater modules (132) on the heater body (131) is arranged on one side. Extra parts for the heater module (132) are set outside the junction groove (131b) to form a plurality of grooved for the heater body (131).

A dispersion plate (133) to connect the heater body (131) on the canister body (11) is formed on the lower surface of the heater body (131). A plurality of hooks (134) are set outside the dispersion plate (133).

The dispersion plate (133) may have the same outer diameter with junction pipe (11c) on the canister body (11).

The dispersion plate (133) may be connected with the junction pipe (11c) on the canister body (11). The hooks (134) are connected with the junction convex (11e) on the canister body (11).

As described above, the junction pipe (11c) inserted on the inner side of the dispersion plate (133) is sealed by a seal component (O) on the junction pipe (11c). The heater (13) is connected with the canister body (11) to form junction convex (11e) of hook (134) to prevent the heater (13) from separating with the canister body (11).

The heater module (132) is composed of a mounting plate (132a) to fix heater module (132) onto the heater body (131) and a PTC heater (132b) fastened onto the mounting plate (132a).

The heating groove (132c) to ensure more effective contact of the heat from the PTC heater (132b) with air is arranged on two sides of the PTC heater (132b).

A power supply terminal (132d) supplying electric power to the PTC heater (132b) is set on the other side of mounting plate (132a) without the PTC heater (132b). The power supply terminal (132d) is connected through the same power wire with vehicle engine.

A plurality of holes is formed on the mounting plate (132a) to fix extra connecting materials of the mounting plate (132a) onto heater body (131).

Although it is not shown in the figure, the heater body (131) is connected with the heater module (132) through a gasket. Moreover, a control module to control PTC heater (132b) is arranged on the heater module (132).

When the heater module (132) as described above is combined with the heater body (131), the PTC heater (132B) and the heating groove (132C) will be horizontally fixed onto heater body (131). At the same time, air flowing in through the air inlet (131a) will flow through the PTC heater (132b) and heating groove (132c) vertically.

As described above, the PTC heater (132b) (Positive Temp. Coefficient), which is anticipated to be heated to 150 to 180° C., will be utilized. In addition to the PTC heater (132B), other heaters with excellent thermal efficiencies may also be adopted.

The power supply terminal (132d) as described above will be connected with an automobile generator and other power supply equipment through a power wire. It is proposed to set power source needed to support the normal operation of the automobile engine on the power supply terminal (132d) reasonably. When the engine starts running, the PTC heater (132b) will be supplied with power and starts to work.

Outer diameter of the dispersion plate (133) may be identical to internal shape and diameter of the heater body.

The dispersion plate (133) as described above is configured with a plurality of holes (133a) on the face and convex parts (133b) at the center.

The dispersion plate (133) and the upper parts of the heater module (132) on the heater body may be connected to the heater body (131) by extra connecting pieces.

In addition, the air flowing in through the air inlet (131a) will be evenly scattered by holes (133a) on the dispersion plate (133). After that, the air will get trough heater module (132) vertically. Therefore, the air can be heated by heater module (132) more effectively than the air flowing in through the air inlet (131a).

In order to reserve a space for air diffusion, the dispersion plate (133) and heater module (132) as described above may be separately installed at specific interval. To ensure enough space between the heater module and the heater body for air diffusion, the heater modules (132) may be separately installed from the lower side of the heater body (131) at a predetermined interval.

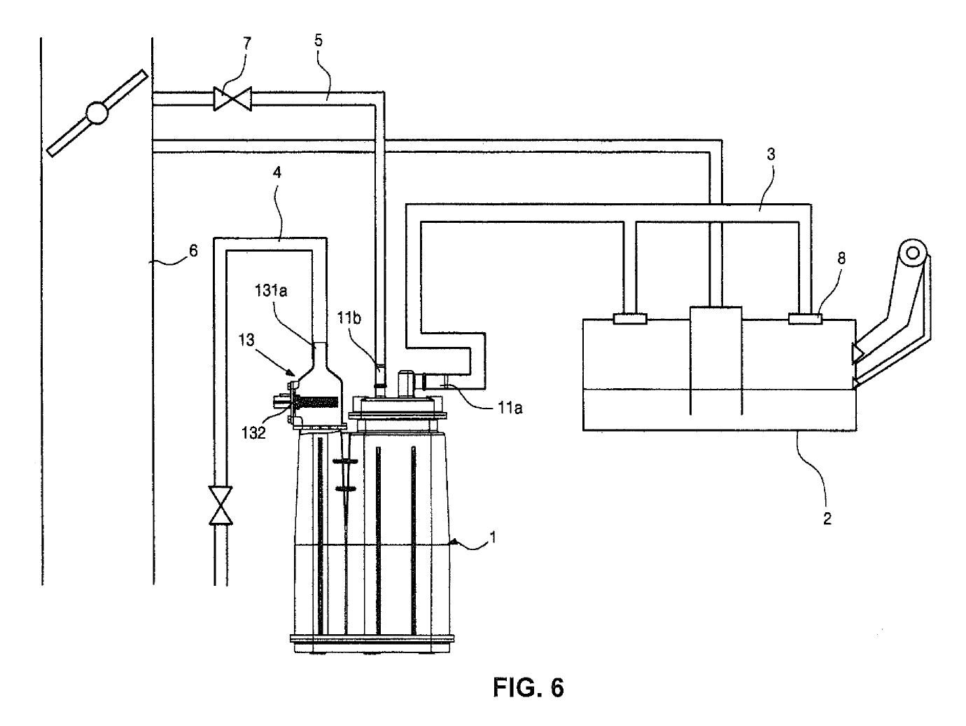

With reference to FIG. 6, the following will describe a working mechanism for the device configured with structures as described above. FIG. 6 shows an expanded view of a status of connections between a canister of the invention and a fuel tank.

As shown in FIG. 6, liquid fuel stored in fuel tank (2) will get gasified due to external temperature impact when the engine is not working. Due to the impact of this kind of fuel gas, pressure of air in fuel tank (2) will rise. With the air pressure as described above, gasified fuel gas will flow into the canister (1) and fuel tank port (11a) through inflow pipe (3) connected with fuel tank (2).

After the fuel tank port (11a), fuel gas will flow downwards through the first space inside the canister (1) and then flow into the second space.

At this time, the fuel gas will encounter active carbon filled in the canister (1). After being gasified, fuel gas will be absorbed onto the active carbon. If it fails to be absorbed, the fuel gas will be discharged from the air inlet (131a).

When driver starts the car to keep the engine under working condition, pressure of the air in the throttle pipe (6) will decline and the control valve (7) is open at the same time. As shown in FIG. 6, the external air will approach canister (1) through discharge pipe (4) and the air inlet (131a) and then flow against the fuel flow direction into the canister (1). Afterwards, the air will come into the throttle pipe (6) through the cleaning port (11b) and the guide pipe (5) and be supplied to the engine.

After being started, the engine will supply power to the PTC heater (132b) installed on the canister (1). After being supplied with power, the PTC heater (132b) will be heated to 150° C. to 180° C. by 3-6 A current. Air flowing from the air inlet (131a) will be heated by heat emitted from the PTC heater (132b) in the process of passing through heating groove (132c). At this time, heated air will flow into the canister body (11) through the groove (11d) on the canister body (11).

Air flowing from air inlet (131a) will be scattered by the dispersion plate (133) and then passes through space between the dispersion plate (133) and the heater module (132). Thereafter, it will flow through the heater module (132). After being heated to 80° C. to 100° C. by the heater module (132), the air will be scattered in the lower space of the heater module (132) and guided to the canister body (11).

Heat generated in the PTC heater (132b) will be supplied to active carbon (50) filled in the canister (1).

The PTC heater (132b) will heat the air flowing from the air inlet (131a) to the canister (1) to about 100° C. Heat generated in the PTC heater (132b) will be supplied to active carbon filled in the canister (1).

After the temperature of the active carbon rises, the liquefied fuel gas absorbed on the active carbon will be gasified. Fuel gas gasified in the canister (1) will flow together with the air flowing from the air inlet (131a) and be finally discharged through the cleaning port (11b).

In the case as described above, when the engine is in the working state, the PTC heater (132b) will be driven to heat the active carbon (50) filled in canister (1) and heat the air flowing from the air inlet (131a). Consequently, the liquefied fuel absorbed on active carbon is easily gasified again. Most fuels originally absorbed on the active carbon will also get gasified and then be discharged through the cleaning port (11b).

The invention relates to a canister equipped with a heater. Air shall be first heated by the heater and then provided to the canister. Active carbon is utilized to absorb the heat generated in the heater to discharge fuel gas absorbed on the active carbons more efficiently.

The PTC heater requires a suitable current (e.g., 3-6 A) to maintain normal operations. In other words, lower currents are used to heat air to 80° C. to 110° C., which will effectively reduce power consumption of hybrid cars but slightly increase fuel costs.

Canister body is connected with a heater by one or more hooks. During installation, the previous heater can be easily removed and a new one may be easily installed and fixed.

The content as above just describes one practical case about the invention. However, the invention is not limited to the described terms. As long as technical concepts of the invention are not violated, various forms are feasible.

What is claimed is:

1. A canister for use with a fuel tank and a throttle pipe to absorb fuel gas from the fuel tank, comprising:
a fuel tank port and an air inlet disposed at an upper end of one side of the canister;
a junction pipe and a canister body with a plurality of junction convexes are arranged on the one side;
a junction configure to fit the junction pipe is formed at an upper end of the canister body, wherein the junction is configured with a plurality of hooks for connection with a plurality of junction convexes on the canister body;
an air inlet is deployed at the upper end of the canister body; and
a heater connected with a heater module is set inside the canister.

2. The canister of claim 1, further comprising a groove on an outer side of junction pipe for inserting a gland strip.

3. The canister of claim 1, wherein the heater comprises an opening set on a lower side of the heater and a heater body with junction holes to hold the heater module, wherein the heater module is horizontally inserted into a junction hole in an upper part on one side of the heater body.

4. The canister of claim 3, wherein the heater module comprises a junction plate, a PTC heater connected with the junction plate, a heating groove connected with the PTC heater, and a power supply terminal to supply electric power to the PTC heater.

5. The canister of claim 3, wherein the canister is configured with the heater module, inserted into the heater body, with a dispersion plate inserted between the heater body and the heater module.

6. The canister of claim 5, wherein the heater module is separately installed at a predetermined interval from the dispersion plate.

7. The canister of claim 3, wherein the heater module is installed at a predetermined distance from a lower side of the heater.

8. The canister of claim 1, wherein air flowing in through the air inlet is heated when passing vertically through a PTC heater and a heating groove, wherein heat generated in the PTC heater is absorbed into active carbons filled in the canister.

9. The canister of claim 5, wherein the dispersion plate is configured with a plurality of holes for air diffusion, and convexes are designed in a middle part of the dispersion plate.

10. The canister of claim 3, wherein the PTC heater requires 3-6 A current to maintain normal operation and will gain a temperature of 150° C. to 180° C.

11. The canister of claim 8, wherein the air flowing towards the canister is heated to 80° C. to 110° C. by the PTC heater.

12. The canister of claim 3, wherein air flowing in through the air inlet will be heated when passing vertically through a PTC heater and a heating groove, wherein heat generated in the PTC heater is absorbed into active carbons filled in the canister.

13. The canister of claim 12, wherein the air flowing towards the canister is heated to 80° C. to 110° C. by the PTC heater.
